(19) United States
(12) Patent Application Publication
(10) Pub. No.: US 2024/0361911 A1
(43) Pub. Date: Oct. 31, 2024

(54) Statistically Driven Run Level Firmware Migration

(71) Applicant: Western Digital Technologies, Inc., San Jose, CA (US)

(72) Inventors: Bharath RADHAKRISHNAN, Penang (MY); Uthayarajan A/L RASALINGAM, Penang (MY)

(73) Assignee: Western Digital Technologies, Inc., San Jose, CA (US)

(21) Appl. No.: 18/218,876

(22) Filed: Jul. 6, 2023

Related U.S. Application Data
(60) Provisional application No. 63/462,960, filed on Apr. 28, 2023.

(51) Int. Cl. G06F 3/06

(52) U.S. Cl. CPC G06F 3/0613; G06F 3/0635; G06F 3/0689

(57) ABSTRACT

During operation of a data storage device, a controller of the data storage device is configured to monitor a usage pattern of the data storage device based on commands sent by a host device. The usage pattern may reflect that the host device is primarily sending write commands or read commands. Because the host device is primarily sending one type of command, the controller may change an allocation of bandwidth/resources of the data storage device to better service the identified command type being sent by the host device. In other words, an increased amount of bandwidth/resources may be allocated to the operations/processes associated with the identified command type and the bandwidth/resources allocated to the non-identified command types may be decreased. Thus, more resources and bandwidth are dedicated to processing the identified command type.

### CROSS-REFERENCE TO RELATED APPLICATIONS

This application claims benefit of U.S. Provisional Patent Application Ser. No. 63/462,960, filed Apr. 28, 2023, which is herein incorporated by reference.

### BACKGROUND OF THE DISCLOSURE

### Field of the Disclosure

Embodiments of the present disclosure generally relate to data storage devices, such as solid state drives (SSDs), and, more specifically, increasing throughput and latency of the data storage device based on usage patterns of the data storage device.

### Description of the Related Art

During run-time of a data storage device, the data storage device may receive a plurality of commands from a host device coupled to the data storage device. Generally, resources and bandwidth of the data storage device may be equally allocated to performing read commands and to performing write commands. However, during run-time, the host device may send one type of command to the data storage device, such as write commands, for a particular period of time. Because a specific amount of resources and bandwidth are allocated to perform a specific type of command, the amount of commands received by the host device may cause a bottleneck to occur. In other words, if only write commands are being sent by the host device, the resources and bandwidth allocated to performing the write commands may not be adequate to avoid having a bottleneck occur. Likewise, because only write commands are being sent by the host device, the resources and bandwidth allocated to performing read commands is unused, thus, wasting available resources and bandwidth.

Therefore, there is a need in the art for an improved bandwidth and resource optimization and allocation based on a usage pattern of the data storage device in order to achieve improved throughput and latency of the data storage device.

### SUMMARY OF THE DISCLOSURE

The present disclosure generally relates to data storage devices, such as solid state drives (SSDs), and, more specifically, increasing throughput and latency of the data storage device based on usage patterns of the data storage device. During operation of a data storage device, a controller of the data storage device is configured to monitor a usage pattern of the data storage device based on commands sent by a host device. The usage pattern may reflect that the host device is primarily sending write commands or read commands. Because the host device is primarily sending one type of command, the controller may change an allocation of bandwidth/resources of the data storage device to better service the identified command type being sent by the host device. In other words, an increased amount of bandwidth/resources may be allocated to the operations/processes associated with the identified command type and the bandwidth/resources allocated to the non-identified command types may be decreased. Thus, more resources and bandwidth are dedicated to processing the identified command type.

In one embodiment, a data storage device includes a memory device and a controller coupled to the memory device. The controller is configured to monitor a usage pattern of the data storage device, receive and process at least one command during the monitoring, where the at least one command is received from a host device, and adjust firmware routines of the data storage device from a current firmware routine based on the monitored usage pattern, where adjusting the firmware routines includes shifting a total bandwidth of the data storage device to be primarily allocated to performing read commands or to be primarily allocated to performing write commands.

In another embodiment, a data storage device includes a memory device and a controller coupled to the memory device. The controller is configured to initiate a usage pattern tracking operation, receive one or more commands from a host device, determine whether each command the one or more commands is a read command or a write command, determine that a predetermined period of time has elapsed from initiating the usage pattern tracking operation, and change a firmware routine of the data storage device from a current firmware routine to a different firmware routine based on the usage pattern tracking operation, where changing the firmware routine to the different firmware routine includes adjusting a first bandwidth of a total bandwidth allocated to performing read operations from a current first bandwidth and a second bandwidth of the total bandwidth allocated to performing write operations from a current second bandwidth.

In another embodiment, a data storage device includes means for storing data and a controller coupled to the means for storing data. The controller is configured to adjust a bandwidth and a resource allocation of the data storage device from a first firmware routine to a second firmware routine. The bandwidth and the resource allocation of the data storage device includes a first allocation for read commands and a second allocation for write commands. The adjusting includes adjusting the first allocation and the second allocation from being equally allocated to being unequally allocated, adjusting the first allocation from being greater than the second allocation to the second allocation being greater than the first allocation, or adjusting the second allocation from being greater than the first allocation to the first allocation being greater than the second allocation.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram illustrating a storage system in which a data storage device may function as a storage device for a host device, according to certain embodiments.

FIG. 2 is a flow diagram illustrating a method of changing a resource and bandwidth allocation based on a usage pattern of the data storage device, according to certain embodiments.

FIG. 3 is a flow diagram illustrating a method of monitoring a usage pattern of the data storage device, according to certain embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specifically described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

The present disclosure generally relates to data storage devices, such as solid state drives (SSDs), and, more specifically, increasing throughput and latency of the data storage device based on usage patterns of the data storage device. During operation of a data storage device, a controller of the data storage device is configured to monitor a usage pattern of the data storage device based on commands sent by a host device. The usage pattern may reflect that the host device is primarily sending write commands or read commands. Because the host device is primarily sending one type of command, the controller may change an allocation of bandwidth/resources of the data storage device to better service the identified command type being sent by the host device. In other words, an increased amount of bandwidth/resources may be allocated to the operations/processes associated with the identified command type and the bandwidth/resources allocated to the non-identified command types may be decreased. Thus, more resources and bandwidth are dedicated to processing the identified command type.

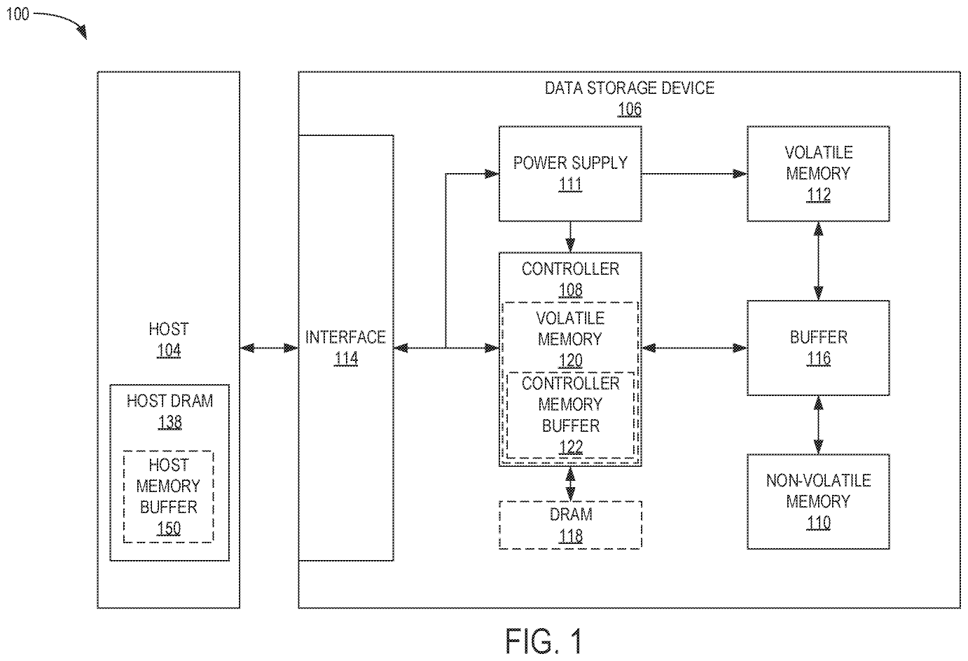

FIG. 1 is a schematic block diagram illustrating a storage system 100 having a data storage device 106 that may function as a storage device for a host device 104, according to certain embodiments. For instance, the host device 104 may utilize a non-volatile memory (NVM) 110 included in data storage device 106 to store and retrieve data. The host device 104 comprises a host DRAM 138. In some examples, the storage system 100 may include a plurality of storage devices, such as the data storage device 106, which may operate as a storage array. For instance, the storage system 100 may include a plurality of data storage devices 106 configured as a redundant array of inexpensive/independent disks (RAID) that collectively function as a mass storage device for the host device 104.

The host device 104 may store and/or retrieve data to and/or from one or more storage devices, such as the data storage device 106. As illustrated in FIG. 1, the host device 104 may communicate with the data storage device 106 via an interface 114. The host device 104 may comprise any of a wide range of devices, including computer servers, network-attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or other devices capable of sending or receiving data from a data storage device.

The host DRAM 138 may optionally include a host memory buffer (HMB) 150. The HMB 150 is a portion of the host DRAM 138 that is allocated to the data storage device 106 for exclusive use by a controller 108 of the data storage device 106. For example, the controller 108 may store mapping data, buffered commands, logical to physical (L2P) tables, metadata, and the like in the HMB 150. In other words, the HMB 150 may be used by the controller 108 to store data that would normally be stored in a volatile memory 112, a buffer 116, an internal memory of the controller 108, such as static random access memory (SRAM), and the like. In examples where the data storage device 106 does not include a DRAM (i.e., optional DRAM 118), the controller 108 may utilize the HMB 150 as the DRAM of the data storage device 106.

The data storage device 106 includes the controller 108, NVM 110, a power supply 111, volatile memory 112, the interface 114, a write buffer 116, and an optional DRAM 118. In some examples, the data storage device 106 may include additional components not shown in FIG. 1 for the sake of clarity. For example, the data storage device 106 may include a printed circuit board (PCB) to which components of the data storage device 106 are mechanically attached and which includes electrically conductive traces that electrically interconnect components of the data storage device 106 or the like. In some examples, the physical dimensions and connector configurations of the data storage device 106 may conform to one or more standard form factors. Some example standard form factors include, but are not limited to, 3.5″ data storage device (e.g., an HDD or SSD), 2.5″ data storage device, 1.8″ data storage device, peripheral component interconnect (PCI), PCI-extended (PCI-X), PCI Express (PCIe) (e.g., PCIe x1, x4, x8, x16, PCIe Mini Card, MiniPCI, etc.). In some examples, the data storage device 106 may be directly coupled (e.g., directly soldered or plugged into a connector) to a motherboard of the host device 104.

Interface 114 may include one or both of a data bus for exchanging data with the host device 104 and a control bus for exchanging commands with the host device 104. Interface 114 may operate in accordance with any suitable protocol. For example, the interface 114 may operate in accordance with one or more of the following protocols: advanced technology attachment (ATA) (e.g., serial-ATA (SATA) and parallel-ATA (PATA)), Fibre Channel Protocol (FCP), small computer system interface (SCSI), serially attached SCSI (SAS), PCI, and PCIe, non-volatile memory express (NVMe), OpenCAPI, GenZ, Cache Coherent Interface Accelerator (CCIX), Open Channel SSD (OCSSD), or the like. Interface 114 (e.g., the data bus, the control bus, or both) is electrically connected to the controller 108, providing an electrical connection between the host device 104 and the controller 108, allowing data to be exchanged between the host device 104 and the controller 108. In some examples, the electrical connection of interface 114 may also permit the data storage device 106 to receive power from the host device 104. For example, as illustrated in FIG. 1, the power supply 111 may receive power from the host device 104 via interface 114.

The NVM 110 may include a plurality of memory devices or memory units. NVM 110 may be configured to store and/or retrieve data. For instance, a memory unit of NVM 110 may receive data and a message from controller 108 that instructs the memory unit to store the data. Similarly, the memory unit may receive a message from controller 108 that instructs the memory unit to retrieve data. In some examples, each of the memory units may be referred to as a die. In some examples, the NVM 110 may include a plurality of dies (i.e., a plurality of memory units). In some examples, each memory unit may be configured to store relatively large amounts of data (e.g., 128 MB, 256 MB, 512 MB, 1 GB, 2 GB, 4 GB, 8 GB, 16 GB, 32 GB, 64 GB, 128 GB, 256 GB, 512 GB, 1 TB, etc.).

In some examples, each memory unit may include any type of non-volatile memory devices, such as flash memory devices, phase-change memory (PCM) devices, resistive random-access memory (ReRAM) devices, magneto-resistive random-access memory (MRAM) devices, ferroelectric random-access memory (F-RAM), holographic memory devices, and any other type of non-volatile memory devices.

The NVM 110 may comprise a plurality of flash memory devices or memory units. NVM Flash memory devices may include NAND or NOR-based flash memory devices and may store data based on a charge contained in a floating gate of a transistor for each flash memory cell. In NVM flash memory devices, the flash memory device may be divided into a plurality of dies, where each die of the plurality of dies includes a plurality of physical or logical blocks, which may be further divided into a plurality of pages. Each block of the plurality of blocks within a particular memory device may include a plurality of NVM cells. Rows of NVM cells may be electrically connected using a word line to define a page of a plurality of pages. Respective cells in each of the plurality of pages may be electrically connected to respective bit lines. Furthermore, NVM flash memory devices may be 2D or 3D devices and may be single level cell (SLC), multi-level cell (MLC), triple level cell (TLC), or quad level cell (QLC). It is to be understood in that the listed memory architectures are not intended to be limiting, but to provide examples of possible embodiments. For example, it is contemplated that higher level cell memory may be applicable, such as penta level cell (PLC) memory and the like (e.g., 6-level cell, 7-level cell, etc.). The controller 108 may write data to and read data from NVM flash memory devices at the page level and erase data from NVM flash memory devices at the block level.

The power supply 111 may provide power to one or more components of the data storage device 106. When operating in a standard mode, the power supply 111 may provide power to one or more components using power provided by an external device, such as the host device 104. For instance, the power supply 111 may provide power to the one or more components using power received from the host device 104 via interface 114. In some examples, the power supply 111 may include one or more power storage components configured to provide power to the one or more components when operating in a shutdown mode, such as where power ceases to be received from the external device. In this way, the power supply 111 may function as an onboard backup power source. Some examples of the one or more power storage components include, but are not limited to, capacitors, super-capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

The volatile memory 112 may be used by controller 108 to store information. Volatile memory 112 may include one or more volatile memory devices. In some examples, controller 108 may use volatile memory 112 as a cache. For instance, controller 108 may store cached information in volatile memory 112 until the cached information is written to the NVM 110. As illustrated in FIG. 1, volatile memory 112 may consume power received from the power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)). Likewise, the optional DRAM 118 may be utilized to store mapping data, buffered commands, logical to physical (L2P) tables, metadata, cached data, and the like in the optional DRAM 118. In some examples, the data storage device 106 does not include the optional DRAM 118, such that the data storage device 106 is DRAM-less. In other examples, the data storage device 106 includes the optional DRAM 118.

Controller 108 may manage one or more operations of the data storage device 106. For instance, controller 108 may manage the reading of data from and/or the writing of data to the NVM 110. In some embodiments, when the data storage device 106 receives a write command from the host device 104, the controller 108 may initiate a data storage command to store data to the NVM 110 and monitor the progress of the data storage command. Controller 108 may determine at least one operational characteristic of the storage system 100 and store at least one operational characteristic in the NVM 110. In some embodiments, when the data storage device 106 receives a write command from the host device 104, the controller 108 temporarily stores the data associated with the write command in the internal memory or write buffer 116 before sending the data to the NVM 110.

The controller 108 may include an optional second volatile memory 120. The optional second volatile memory 120 may be similar to the volatile memory 112. For example, the optional second volatile memory 120 may be SRAM. The controller 108 may allocate a portion of the optional second volatile memory 120 to the host device 104 as controller memory buffer (CMB) 122. The CMB 122 may be accessed directly by the host device 104. For example, rather than maintaining one or more submission queues in the host device 104, the host device 104 may utilize the CMB 122 to store the one or more submission queues normally maintained in the host device 104. In other words, the host device 104 may generate commands and store the generated commands, with or without the associated data, in the CMB 122, where the controller 108 accesses the CMB 122 in order to retrieve the stored generated commands and/or associated data.

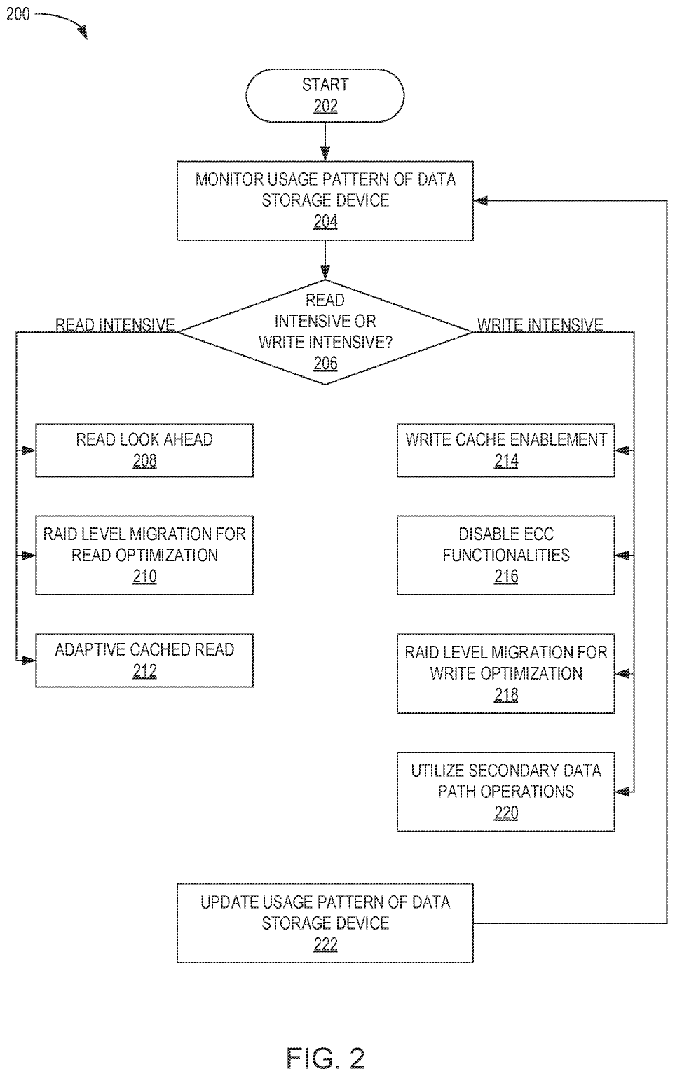

FIG. 2 is a flow diagram illustrating a method 200 of changing a resource and bandwidth allocation based on a usage pattern of the data storage device, such as the data storage device 106 of FIG. 1, according to certain embodiments. For exemplary purposes, aspects of the storage system 100 of FIG. 1 may be referenced herein. For example, controller 108 may be configured to execute method 200. It is to be understood that in the description herein, bandwidth is used and described, but the embodiments described herein may additionally or alternatively be applicable to resources of the data storage device 106.

At block 202, method 200 starts. For example, method 200 may start when the data storage device 106 is initiated, which may include after a predetermined amount of time has elapsed since a reset event (e.g., power reset, link reset, etc.), or in response to an identified condition of the data storage device 106. For example, when a reset event occurs to the data storage device 106 (e.g., any event that causes the data storage device 106 to power down and power up), the predetermined amount of time may be 45 minutes. After the 45 minutes has elapsed, method 200 starts. It is to be understood that the value previously described is not intended to be limiting, but to provide an example of a possible embodiment. For example, the predetermined amount of time may be based on a statistical average for the data storage device 106 to enter a steady-state environment or for the host device 104 to send commands and data at a constant rate. Furthermore, the identified condition may be a change in a workload type, a time threshold elapsing, where the time threshold is an amount of time since the last time method 200 has occurred, or after a threshold bandwidth of the data storage device 106 has been exceeded. It is to be understood that the previously listed examples are not intended to be limiting, but to provide an example of a possible embodiment.

At block 204, the controller 108 monitors a usage pattern of the data storage device 106. The monitoring may be for a predetermined period of time, such as for a 10 minute time span. It is to be understood that the listed predetermined period of time is not intended to be limiting, but to provide an example of a possible embodiment. At block 206, after the monitoring ends, the controller 108 determines whether the usage pattern of the data storage device 106 is read intensive or write intensive during the monitored time period in order to adjust a firmware routine of the data storage device 106. For example, read intensive may be classified as having a workload of greater than about 50% of the workload. Likewise, write intensive may be classified as having a workload of greater than about 50% of the workload. The classifying may be based on a number of commands received, a size of a command received, or both the number of commands received and the sizes of the commands received. For example, the amount quantified may be based on a total terabytes written (TBW) parameter or total terabytes read parameter. In other examples, read intensive and write intensive may be classified by which workload has a simple majority. It is to be understood that the term “about” utilized may refer to a range of plus or minus 5%. Furthermore, the threshold for classifying a workload as being read intensive or write intensive may be a factory preset, a host device prompted threshold set by the host device, or a dynamic threshold based on available resources and bandwidth of the data storage device 106.

If the usage pattern was read intensive at block 206, the controller 108 may adjust its bandwidth allocation for read commands (i.e., increases the bandwidth for performing read commands) in order to perform one or more of increasing a number of read look ahead operations at block 208, migrating data to a different redundant array of independent disks (RAID) level having increased read capabilities (e.g., RAID 0) at block 210, and performing adaptive cached read operations, which may include using buffers normally utilized for write operations to store read data in advance of receiving a read command for the data based on a recently received read command having a logical block address (LBA) range and data size, at block 212. Further operations may include performing stronger error correction code (ECC) operations (e.g., higher powered decoding operations), reducing an amount or frequency of garbage collection operations, handling an increased amount of read error recovery operations, reducing a number of erase operations, and the like. When the controller 108 increases the bandwidth for performing read commands, the controller 108 may decrease the bandwidth for performing write operations. Furthermore, the controller 108 power down completely or in a low power state components of the data storage device 106 that are utilized for write operations, such as encoders, write buffers, and the like.

If the usage pattern was write intensive at block 206, the controller 108 may adjust its bandwidth allocation for write commands (i.e., increases the bandwidth for performing write commands) in order to perform one or more of enabling additional or larger write caches at block 214, disabling certain ECC functionalities, such as decoders, at block 216, migrating data to a different RAID level having increased write capabilities (e.g., RAID 1/5/6) at block 218, and utilizing secondary data path operations, such as generating additional ECC data, increased parity striping, and the like, at block 220. Further operations may include triggering garbage collection operations more frequently, optimizing write related error handling, and handling erase operations. When the controller 108 increases the bandwidth for performing write commands, the controller 108 may decrease the bandwidth for performing read operations. Furthermore, the controller 108 power down completely or in a low power state components of the data storage device 106 that are utilized for read operations, such as decoders, read buffers, and the like. At block 222, the usage pattern is updated based on the monitored usage pattern.

When the data storage device 106 is initiated, resources and bandwidth of the data storage device 106 may be evenly allocated to performing read commands and performing write commands. For example, 50% of the bandwidth and resource allocation may be allocated to performing read commands and 50% of the bandwidth and resource allocation may be allocated to performing write commands. However, based on the usage pattern of the data storage device 106, the allocation percentage (i.e., firmware routine) for each command type may be adjusted such that a greater amount of resources and bandwidth are allocated to perform the identified command type (or workload type) in order to increase performance and throughput and decrease latency. In embodiments where a shift occurs, a maximum shift of about 80% bandwidth/resources may be allocated to an identified command type, such that about 20% bandwidth/resources remain allocated to the non-identified command type. Furthermore, the shift may be an incremental shift or a preset shift dependent on the usage pattern.

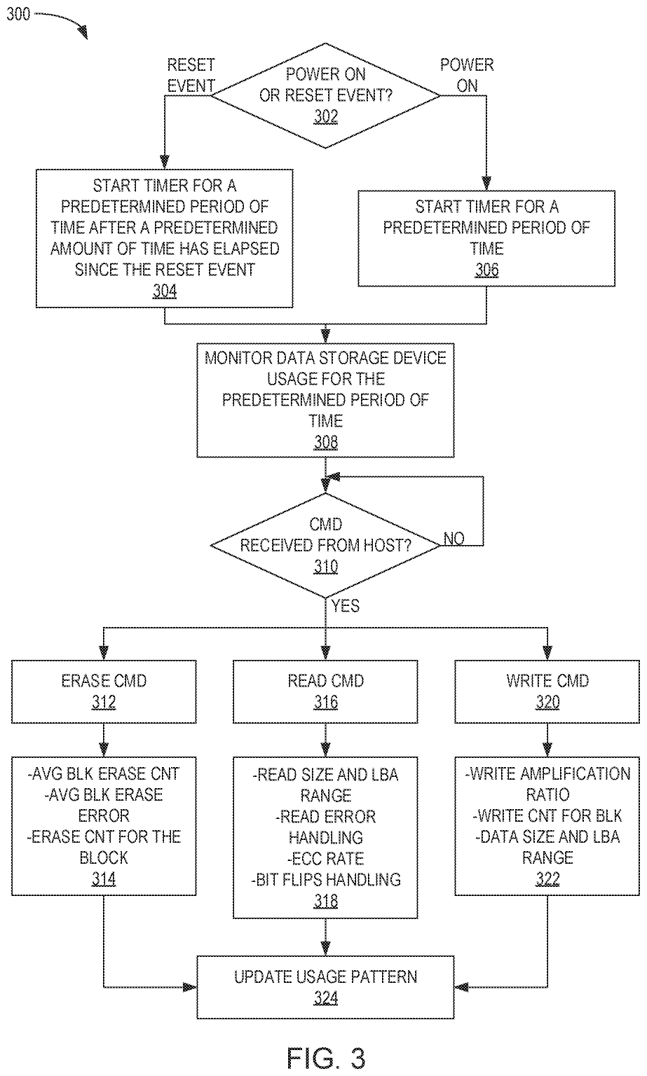

FIG. 3 is a flow diagram illustrating a method 300 of monitoring a usage pattern of the data storage device, such as the data storage device 106 of FIG. 1, according to certain embodiments. For exemplary purposes, aspects of the storage system 100 of FIG. 1 may be referenced herein. For example, controller 108 may be configured to execute method 200. It is to be understood that in the description herein, bandwidth is used and described, but the embodiments described herein may additionally or alternatively be applicable to resources of the data storage device 106.

At block 302, the controller 108 determines if the data storage device 106 is powered on without a reset event occurring within a predetermined amount of time or a reset event has occurred within the predetermined amount of time. If the reset event has occurred within the predetermined amount of time, the controller 108 starts a timer for a predetermined period of time after the predetermined amount of time has elapsed since the reset event at block 304. However, if a reset event has not occurred within the predetermined amount of time at block 302, then the controller 108 starts a timer for the predetermined period of time. The predetermined amount of time may be 45 minutes. The predetermined period of time may be 10 minutes. It is to be understood that the listed values are not intended to be limiting, but to provide an example of possible embodiments.

When the timer is initiated at block 304 or at block 306, method 300 advances to block 308, where the controller 108 monitors the usage of the data storage device for the predetermined period of time in order to generate a usage pattern of the data storage device. At block 310, the controller 108 determines if a command has been received from the host device 104. If a command has not been received from the host device 104 at block 310, then method 300 waits at block 310 for a command to be received from the host device 104 during the predetermined period of time. However, if a command has been received from the host device 104 at block 310, then the controller 108 categorizes the command as either an erase command at block 312, a read command at block 316, or a write command at block 320.

If the command is an erase command at block 312, then statistics regarding the erase command are generated and stored at block 314. The statistics may include an average block erase count, an average block erase error, an erase count for the particular block, and the like. If the command is a read command at block 316, then statistics regarding the read command are generated and stored at block 318. The statistics may include a read size and LBA range of the read command, a read error handling of the read command, an ECC rate of the read command, bit flip handling of the read command, and the like. If the command is a write command at block 320, then statistics regarding the write command are generated at stored at block 322. The statistics may include a write amplification ratio of the block associated with the write command, a write count for the block, a data size and LBA range of the block, and the like. The statistics and identified drive usage pattern may be stored in a log, which may be stored in the NVM 110 or a volatile memory, such as the volatile memory 112 or the optional second volatile memory 120. The log may be Self Monitoring Analysis and Reporting Technique (SMART) logs, page logs, vendor logs, input/output meter output, and usage pattern change activity logs. The logs may be used by the firmware or by software updates in order to better optimize the bandwidth and resource allocation model utilized by the controller 108.

At block 324, based on the commands received from the host device 104 at block 310, the usage pattern is updated, which may influence the controller 108 to optimize the bandwidth and resource allocation of the data storage device 106 based on the usage pattern in order to improve throughput and decrease latency, as described in method 200. The updating of the usage pattern may occur when the predetermined period of time has elapsed. Furthermore, the usage pattern may be updated to reflect which command type was identified to be the majority command type received or updated to reflect a percentage of each command types identified. Based on the usage pattern, the bandwidth and resource allocation of the data storage device 106 may be adjusted by the controller 108.

By monitoring a usage pattern of the data storage device and adapting firmware operations by increasing/decreasing bandwidth and resources allocated to executing different command types, overall data storage device performance, quality of service, throughput, and latency may be improved.

In one embodiment, a data storage device includes a memory device and a controller coupled to the memory device. The controller is configured to monitor a usage pattern of the data storage device, receive and process at least one command during the monitoring, where the at least one command is received from a host device, and adjust firmware routines of the data storage device from a current firmware routine based on the monitored usage pattern, where adjusting the firmware routines includes shifting a total bandwidth of the data storage device to be primarily allocated to performing read commands or to be primarily allocated to performing write commands.

The controller is further configured to determine whether the data storage device has undergone a power reset operation. Responsive to determining that the data storage device has undergone the power reset operation, the monitoring begins after a predetermined amount of time has elapsed after the power reset operation. Responsive to determining that the data storage device has not undergone a power reset operation, the monitoring occurs after a predetermined amount of time has elapsed after the adjusting. The monitoring occurs for a predetermined period of time. Shifting the total bandwidth of the data storage device to be primarily allocated to performing read commands includes one or more of performing an increased number of read look ahead operations, migrating data to a different redundant array of independent disks (RAID) level having increased read capabilities, and performing adaptive cached read operations. Shifting the total bandwidth of the data storage device to be primarily allocated to performing write commands includes one or more of enabling a write cache, disabling error correction code (ECC) correction functionalities, migrating data to a different redundant array of independent disks (RAID) level having increased write capabilities, and performing data path operations requiring additional processing power than current data path operations. The usage pattern is either a read intensive usage or a write intensive usage. The controller is further configured to shift the total bandwidth of the data storage device to be primarily allocated to performing read commands when the usage pattern is the read intensive usage and shift the total bandwidth of the data storage device to be primarily allocated to performing write commands when the usage pattern is the write intensive usage. The controller is further configured to store data logs storing the monitored usage pattern.

In another embodiment, a data storage device includes a memory device and a controller coupled to the memory device. The controller is configured to initiate a usage pattern tracking operation, receive one or more commands from a host device, determine whether each command the one or more commands is a read command or a write command, determine that a predetermined period of time has elapsed from initiating the usage pattern tracking operation, and change a firmware routine of the data storage device from a current firmware routine to a different firmware routine based on the usage pattern tracking operation, where changing the firmware routine to the different firmware routine includes adjusting a first bandwidth of a total bandwidth allocated to performing read operations from a current first bandwidth and a second bandwidth of the total bandwidth allocated to performing write operations from a current second bandwidth.

The first current bandwidth and the second current bandwidth are equal for the current firmware routine. The first bandwidth and the second bandwidth are not equal for the different firmware routine. Initiating the usage pattern tracking operation occurs after a predetermined amount of time has elapsed since a usage of the data storage device has exceeded a threshold usage. Initiating the usage pattern tracking operation occurs after a predetermined amount of time has elapsed after a power cycle operation. The controller, for the read command, is further configured to perform one or more of tracking a read size and a logical block address (LBA) range of the read command, tracking read error handling associated with the read command, tracking an error correction code (ECC) rate associated with the read command, and tracking bit flip handling associated with the read command. The controller, for the write command, is further configured to perform one or more of tracking a write amplification ratio for the write command, tracking a write count of a block of the memory device associated with the write command, and tracking a data size and a logical block address (LBA) range associated with the write command.

In another embodiment, a data storage device includes means for storing data and a controller coupled to the means for storing data. The controller is configured to adjust a bandwidth and a resource allocation of the data storage device from a first firmware routine to a second firmware routine. The bandwidth and the resource allocation of the data storage device includes a first allocation for read commands and a second allocation for write commands. The adjusting includes adjusting the first allocation and the second allocation from being equally allocated to being unequally allocated, adjusting the first allocation from being greater than the second allocation to the second allocation being greater than the first allocation, or adjusting the second allocation from being greater than the first allocation to the first allocation being greater than the second allocation.

The controller is further configured to monitor a usage pattern of the data storage device for a predetermined period of time, determine whether the usage pattern comprises a greater number of read commands or a greater number of write commands, and perform the adjusting based on the determining. The monitoring is responsive to either determining that a power cycle operation has occurred or a predetermined amount of time has elapsed since last adjusting of the bandwidth and the resource allocation.

While the foregoing is directed to embodiments of the present disclosure, other and further embodiments of the disclosure may be devised without departing from the basic scope thereof, and the scope thereof is determined by the claims that follow.

What is claimed is:

1. A data storage device, comprising:
a memory device; and
a controller coupled to the memory device, wherein the controller is configured to:
monitor a usage pattern of the data storage device;
receive and process at least one command during the monitoring, wherein the at least one command is received from a host device; and
adjust firmware routines of the data storage device from a current firmware routine based on the monitored usage pattern, wherein adjusting the firmware routines comprises shifting a total bandwidth of the data storage device to be primarily allocated to performing read commands or to be primarily allocated to performing write commands.

2. The data storage device of claim 1, wherein the controller is further configured to determine whether the data storage device has undergone a power reset operation.

3. The data storage device of claim 2, wherein, responsive to determining that the data storage device has undergone the power reset operation, the monitoring begins after a predetermined amount of time has elapsed after the power reset operation.

4. The data storage device of claim 2, wherein, responsive to determining that the data storage device has not undergone a power reset operation, the monitoring occurs after a predetermined amount of time has elapsed after the adjusting.

5. The data storage device of claim 1, wherein the monitoring occurs for a predetermined period of time.

6. The data storage device of claim 1, wherein shifting the total bandwidth of the data storage device to be primarily allocated to performing read commands comprises one or more of:
performing an increased number of read look ahead operations;
migrating data to a different redundant array of independent disks (RAID) level having increased read capabilities; and
performing adaptive cached read operations.

7. The data storage device of claim 1, wherein shifting the total bandwidth of the data storage device to be primarily allocated to performing write commands comprises one or more of:
enabling a write cache;
disabling error correction code (ECC) correction functionalities;
migrating data to a different redundant array of independent disks (RAID) level having increased write capabilities; and
performing data path operations requiring additional processing power than current data path operations.

8. The data storage device of claim 1, wherein the usage pattern is either a read intensive usage or a write intensive usage.

9. The data storage device of claim 8, wherein the controller is further configured to:
shift the total bandwidth of the data storage device to be primarily allocated to performing read commands when the usage pattern is the read intensive usage; and
shift the total bandwidth of the data storage device to be primarily allocated to performing write commands when the usage pattern is the write intensive usage.

10. The data storage device of claim 1, wherein the controller is further configured to store data logs storing the monitored usage pattern.

11. A data storage device, comprising:
a memory device; and
a controller coupled to the memory device, wherein the controller is configured to:
initiate a usage pattern tracking operation;
receive one or more commands from a host device;
determine whether each command the one or more commands is a read command or a write command;
determine that a predetermined period of time has elapsed from initiating the usage pattern tracking operation; and
change a firmware routine of the data storage device from a current firmware routine to a different firmware routine based on the usage pattern tracking operation, wherein changing the firmware routine to the different firmware routine comprises adjusting a first bandwidth of a total bandwidth allocated to performing read operations from a current first bandwidth and a second bandwidth of the total bandwidth allocated to performing write operations from a current second bandwidth.

12. The data storage device of claim 11, wherein, for the current firmware routine, the first current bandwidth and the second current bandwidth are equal.

13. The data storage device of claim 11, wherein, for the different firmware routine, the first bandwidth and the second bandwidth are not equal.

14. The data storage device of claim 11, wherein initiating the usage pattern tracking operation occurs after a predetermined amount of time has elapsed since a usage of the data storage device has exceeded a threshold usage.

15. The data storage device of claim 11, wherein initiating the usage pattern tracking operation occurs after a predetermined amount of time has elapsed after a power cycle operation.

16. The data storage device of claim 11, wherein, for the read command, the controller is further configured to perform one or more of:
tracking a read size and a logical block address (LBA) range of the read command;
tracking read error handling associated with the read command;
tracking an error correction code (ECC) rate associated with the read command; and
tracking bit flip handling associated with the read command.

17. The data storage device of claim 11, wherein, for the write command, the controller is further configured to perform one or more of:
tracking a write amplification ratio for the write command;
tracking a write count of a block of the memory device associated with the write command; and
tracking a data size and a logical block address (LBA) range associated with the write command.

18. A data storage device, comprising:
means for storing data; and
a controller coupled to the means for storing data, wherein the controller is configured to:
adjust a bandwidth and a resource allocation of the data storage device from a first firmware routine to a second firmware routine, wherein:
the bandwidth and the resource allocation of the data storage device comprises a first allocation for read commands and a second allocation for write commands; and
the adjusting comprises:
adjusting the first allocation and the second allocation from being equally allocated to being unequally allocated;
adjusting the first allocation from being greater than the second allocation to the second allocation being greater than the first allocation; or
adjusting the second allocation from being greater than the first allocation to the first allocation being greater than the second allocation.

19. The data storage device of claim 18, wherein the controller is further configured to:
monitor a usage pattern of the data storage device for a predetermined period of time;
determine whether the usage pattern comprises a greater number of read commands or a greater number of write commands; and
perform the adjusting based on the determining.

20. The data storage device of claim 19, wherein the monitoring is responsive to either:
determining that a power cycle operation has occurred; or
a predetermined amount of time has elapsed since last adjusting of the bandwidth and the resource allocation.
